(19) United States
(12) Patent Application Publication
(10) Pub. No.: US 2008/0046344 A1
(43) Pub. Date: Feb. 21, 2008

(54) System and method for managing inventory control processes

(75) Inventors: Gerald Lee Myers, Heyworth, IL (US); Zhiming Qu, East Peoria, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/495,525

(22) Filed: Jul. 31, 2006

(51) Int. Cl. G06Q 10/00

(52) U.S. Cl. 705/28

(57) ABSTRACT

An inventory control process management method comprises establishing a plurality of groups within a product population, each of the plurality of groups having a plurality of products with at least one aspect common to each of the plurality of products. One or more part numbers associated with each of the plurality of groups is selected, wherein a number of selected part numbers is determined based on a total size of a group associated with the selected part number. An actual quantity associated with each of the selected part numbers is determined based on a inventory audit and an inventory error associated with each of the selected part numbers is identified based on a deviation between the determined quantity and an inventory record associated with each of the selected part numbers. The inventory record is modified based on the inventory error. The method also includes comparing the inventory error with a predetermined error threshold and analyzing the inventory control process if the inventory error exceeds the predetermined inventory error threshold. The method further includes modifying an inventory control process based on the analysis.

### TECHNICAL FIELD

The present disclosure relates generally to inventory control and, more particularly, to a system and method for managing inventory control processes.

### BACKGROUND

In many business environments, proper inventory management may be imperative to the operation of the business. For example, inventory management processes may be particularly important for parts suppliers that rely on high-volume transactions in which a large percentage of an inventory population is turned over in a short time. In these types of business environments, it is imperative that each product associated with the inventory is accounted for to ensure that appropriate quantities of each product may be available for prospective customers.

In order to manage inventory, many organizations have developed inventory record adjustment processes. Typically, these processes prescribe, for example, one or more standards for auditing inventory records, when and how often to count actual inventory stocks, and how to reconcile conflicts between inventory records and physical stock counts. When properly executed, these record adjustment processes may allow inventory management personnel to compare inventory stock levels with inventory records and correct inventory records to reflect the actual inventory stock levels.

In certain situations, however, the monitoring and auditing capabilities of conventional inventory control processes may be inadequate. For example, because these processes focus simply on inventory record reconciliation, they may not be designed to identify inventory errors and locate a potential source of error. In short, conventional record adjustment processes may do nothing to address problems associated with an inventory management process that may be vulnerable to and/or cause inventory record discrepancies. Thus, an inventory management system that can identify inventory errors and adjust an inventory control process to correct a source of error, may be required.

At least one method has been developed to assess inventory records and identify errors associated with the records in order to provide recommendations for modifying a current inventory practice. For example, U.S. Patent Publication No.2003/0120563 (“the '563 publication”) to Meyer describes a method of managing inventory that assesses a plurality of inventory records, identifies a discrepancy in at least one record, and resolves the discrepancy. This discrepancy may be resolved by performing an auditing process to account for items in inventory. The method described in the '563 publication may also identify a characteristic associated with the discrepancy and modify the characteristic in order to change the inventory management process.

Although the method of the '563 publication may audit inventory records with respect to actual inventory data in an effort to adjust an inventory management process, it may still be inadequate and prone to error. For example, because the process of the '563 patent randomly selects a plurality of items from a large inventory population, without ensuring that certain statistical sample criteria have been met, the method of the '563 patent may be statistically inadequate for product inventories involving a diverse inventory population. As a result, business environments that rely on statistically robust inventory audits may become inefficient if inventory management processes are adjusted based on statistically inadequate random sample selections.

The presently disclosed system and method for managing inventory control processes is directed toward overcoming one or more of the problems set forth above.

### SUMMARY OF THE INVENTION

In accordance with one aspect, the present disclosure is directed toward a method for managing an inventory control process. The method may include establishing a plurality of groups within a product population, each of the plurality of groups having a plurality of products with at least one aspect common to each of the plurality of products. One or more part numbers associated with each of the plurality of groups may be selected, wherein a number of selected part numbers is determined based on a total size of a group associated with the selected part number. An actual quantity associated with each of the selected part numbers may be determined and an inventory error associated with each of the selected part numbers may be identified based on a deviation between the determined quantity and an inventory record associated with each of the selected part numbers. The inventory record may be modified based on the inventory error. The method may also include comparing the inventory error with a predetermined error threshold and analyzing the inventory control process if the inventory error exceeds the predetermined inventory error threshold. The method may also include modifying an inventory control process based on the analysis.

According to another aspect, the present disclosure is directed toward a method for adjusting an inventory management process. The method may include selecting one or more part numbers associated a product population and collecting physical count data associated with the selected part numbers. An inventory error associated with each of the selected part numbers may be determined based on a deviation between the physical count data and an inventory record associated with each of the selected part numbers. The inventory error may be compared with a predetermined inventory error threshold. An existing inventory control process associated with each part number having an inventory error that exceeds the predetermined error threshold may be analyzed. The method may also include identifying one or more potential sources of inventory error, and providing recommendations for modifying the inventory control process to correct the one or more potential sources of inventory error. An inventory control process may be modified based on the recommendations.

In accordance with yet another aspect, the present disclosure is directed toward a computer readable medium for use on a computer system, the computer readable medium having computer executable instructions for performing a method for managing inventory control processes. The method may include establishing a plurality of groups within a product population, each of the plurality of groups having a plurality of products with at least one aspect common to each of the plurality of products. One or more part numbers associated with each of the plurality of groups may be selected and a quantity associated with each of the selected part numbers may be determined. The method may also include determining an inventory error associated with each of the selected part numbers based on a deviation between the determined quantity and an inventory record associated with each of the selected part numbers. The inventory record may be modified based on the inventory error. The method may also include comparing the inventory error with a predetermined error threshold and analyzing the inventory control process if the inventory error exceeds the predetermined inventory error threshold. The method may also include modifying an inventory control process based on the analysis.

### BRIEF DESCRIPTION OF THE DRAWINGS

FIG. 1 illustrates an exemplary disclosed inventory environment consistent with certain disclosed embodiments;

FIG. 2 provides an exemplary disclosed stratification process for establishing a plurality of groups for a statistical test count process associated with an inventory control process; and

FIG. 3 provides a flowchart depicting an exemplary method for managing an inventory control process consistent with certain disclosed embodiments.

### DETAILED DESCRIPTION

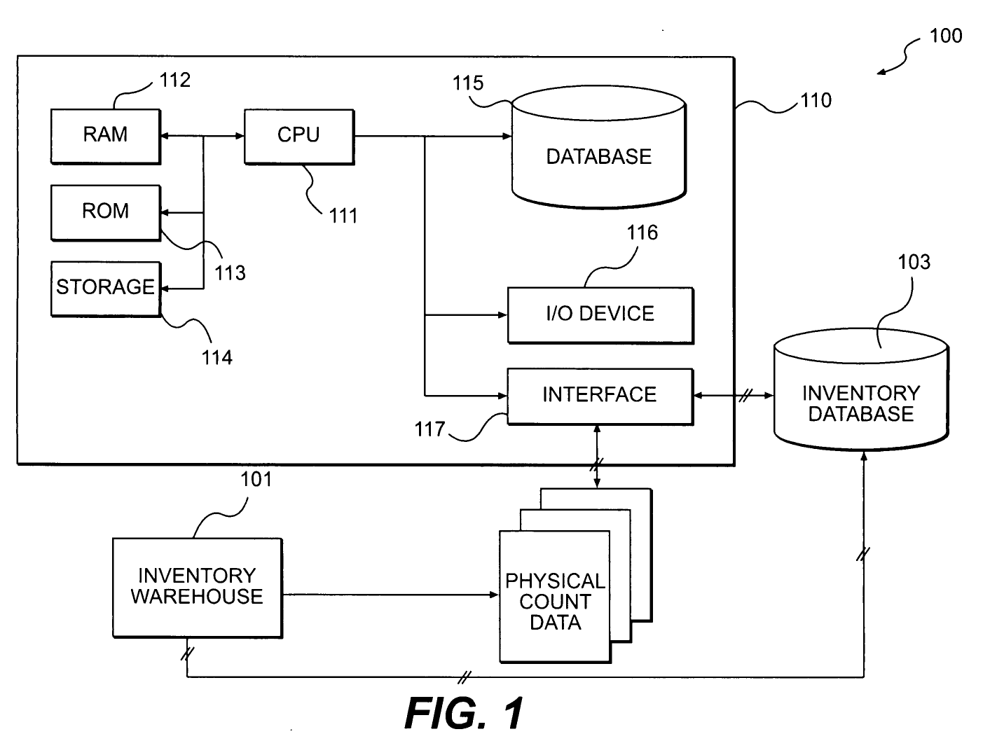

FIG. 1 provides a block diagram illustrating an exemplary disclosed inventory environment 100. Inventory environment 100 may include any type of environment associated with monitoring and/or managing an inventory that includes a population of elements. For example, inventory environment 100 may include a product warehouse configured to receive and distribute large numbers of products for operating a business. Inventory environment 100 may include, among other things, an inventory warehouse 101 containing a plurality of products, an inventory database 103, and a system 110 for maintaining inventory records.

Inventory warehouse 101 may include any type of facility for storing a plurality of products. Products, as the term is used herein, may include any physical or virtual element that may be used as a product associated with a business. Non limiting examples of physical products may include machines or machine parts or accessories such as, for example, electronic hardware or software, work implements, traction devices such as tires, tracks, etc., transmissions, engine parts or accessories, fuel, or any other suitable type of physical product. Non limiting examples of virtual products may include inventory data, product documentation, software structures, software programs, financial data or documents such as stock records, or any other type of virtual product. Inventory warehouse 101 may include, for example, a parts depot, a product showroom, a document storage facility, or any other type of facility suitable for storing physical and/or virtual products.

Inventory database 103 may include any type of electronic data storage device that may store data information. Inventory database 103 may contain one or more inventory records associated with each of the plurality of products associated with inventory warehouse 101. Inventory database 103 may constitute a standalone computer system that includes one or more computer programs for monitoring and/or maintaining inventory records associated therewith. Alternatively and/or additionally, inventory database 103 may be integrated as part of an inventory warehouse computer or system 110 for maintaining inventory records. It is also contemplated that inventory database 103 may include a shared database between one or more computer systems of business entities associated with inventory warehouse 101, such as an accounting division, a sales division, a supplier, or any other appropriate business entity that may typically deal with an inventory warehouse.

System 110 may include any type of processor-based system on which processes and methods consistent with the disclosed embodiments may be implemented. For example, as illustrated in FIG. 1, system 110 may include one or more hardware and/or software components configured to execute software programs, such as software for managing inventory environment 100, inventory monitoring software, or inventory transaction software. For example, system 110 may include one or more hardware components such as, for example, a central processing unit (CPU) 111, a random access memory (RAM) module 112, a read-only memory (ROM) module 113, a storage 114, a database 115, one or more input/output (I/O) devices 116, and an interface 117. Alternatively and/or additionally, system 110 may include one or more software components such as, for example, a computer-readable medium including computer-executable instructions for performing methods consistent with certain disclosed embodiments. It is contemplated that one or more of the hardware components listed above may be implemented using software. For example, storage 114 may include a software partition associated with one or more other hardware components of system 110. System 110 may include additional, fewer, and/or different components than those listed above. It is understood that the components listed above are exemplary only and not intended to be limiting.

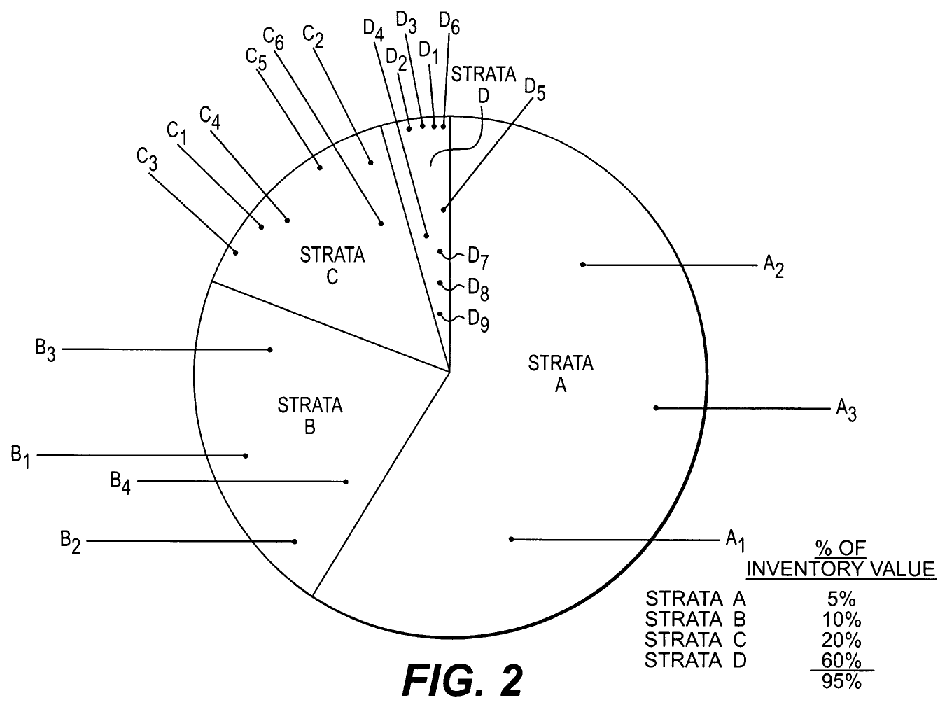

CPU 111 may include one or more processors, each configured to execute instructions and process data to perform one or more functions associated with system 110. As illustrated in FIG. 2, CPU 111 may be communicatively coupled to RAM 112, ROM 113, storage 114, database 115, I/O devices 116, and interface 117. CPU 111 may be configured to execute sequences of computer program instructions to perform various processes, which will be described in detail below. The computer program instructions may be loaded into RAM for execution by CPU 111.

RAM 112 and ROM 113 may each include one or more devices for storing information associated with an operation of system 110 and/or CPU 111. For example, ROM 113 may include a memory device configured to access and store information associated with system 110, including information for identifying, initializing, and monitoring the operation of one or more components and subsystems of system 110. RAM 112 may include a memory device for storing data associated with one or more operations of CPU 111. For example, ROM 113 may load instructions into RAM 112 for execution by CPU 111.

Storage 114 may include any type of mass storage device configured to store information that CPU 111 may need to perform processes consistent with the disclosed embodiments. For example, storage 114 may include one or more magnetic and/or optical disk devices, such as hard drives, CD-ROMs, DVD-ROMs, or any other type of mass media device.

Database 115 may include one or more software and/or hardware components that cooperate to store, organize, sort, filter, and/or arrange data used by system 110 and/or CPU 111. For example, database 115 may include historical data, such as previous adjustments to inventory records based on physical count data and/or previous inventory records. CPU 111 may access the information stored in database 115 for comparing the physical count data with the inventory record data to determine whether an adjustment to the inventory record may be required. CPU 111 may also analyze current and previous inventory count records to identify trends in inventory count adjustment. These trends may then be recorded and analyzed to adjust one or more aspects associated with an inventory control process, which may potentially reduce inventory management errors leading to product loss and/or inventory write-off. It is contemplated that database 115 may store additional and/or different information than that listed above.

I/O devices 116 may include one or more components configured to communicate information with a user associated with system 110. For example, I/O devices may include a console with an integrated keyboard and mouse to allow a user to input parameters associated with system 110. I/O devices 116 may also include a display including a graphical user interface (GUI) for outputting information on a monitor. I/O devices 116 may also include peripheral devices such as, for example, a printer for printing information associated with system 110, a user-accessible disk drive (e.g., a USB port, a floppy, CD-ROM, or DVD-ROM drive, etc.) to allow a user to input data stored on a portable media device, a microphone, a speaker system, or any other suitable type of interface device.

Interface 117 may include one or more components configured to transmit and receive data via a communication network, such as the Internet, a local area network, a workstation peer-to-peer network, a direct link network, a wireless network, or any other suitable communication platform. For example, interface 117 may include one or more modulators, demodulators, multiplexers, demultiplexers, network communication devices, wireless devices, antennas, modems, and any other type of device configured to enable data communication via a communication network.

System 110 may be configured to perform certain tasks associated with a statistical test count process, to identify inventory errors associated with an inventory control process. These inventory errors may assist inventory management personnel in diagnosing a source of error in the inventory management process and modify the process to substantially reduce or eliminate the error.

System 110 may be configured to divide (using a software stratification process) an inventory population into a plurality of subpopulations or groups, called strata, based on one or more predetermined criteria. Using this stratification method, a statistically robust sample may be selected such that any analysis based on the sample may be accurately and confidently extrapolated over the respective subpopulation and/or the entire inventory population.

According to one embodiment, for example, system 110 may execute stratification software that establishes a plurality of groups associated with an inventory population. The number of groups to be established by the stratification software may be predetermined or, alternatively, may be input by a user. Once a number of groups has been established, a stratification criteria may be selected. For purposes of the present disclosure, stratification criteria may include one or more characteristics, such as product price, size, type, storage characteristic (e.g., warehouse location, shelf number) or any other aspect that may be common to each product associated with a particular group. For example, stratification criteria may include a price range associated with each of the plurality of groups. As such, system 110 may consolidate products whose prices fall within a particular range into a common group.

FIG. 2 provides a chart that depicts an exemplary stratification process performed by system 110, in accordance with certain disclosed embodiments. As illustrated in FIG. 2, four different groups (strata) may be established by system 110 based on a percent value associated with each of a plurality of products. Each strata may be associated with a percentage of a total value of an entire of inventory of products. For example, strata A, containing a majority of the part numbers, may correspond to only 5% of the overall value of the inventory. On the other hand, strata D, containing a substantially smaller quantity of high-priced part numbers, may comprise 60% of the total value of the inventory.

Once the groups have been established, system 110 may randomly select one or more part numbers associated with each group. The number of part numbers selected (which corresponds to the sample size for the statistical test count process) may be determined based on one or more of the total number of parts in the strata.

Once the part numbers have been selected, a number of counts to be performed for each of the respective part numbers may be determined. The number of counts may be based on the value of the products in the strata associated with a particular part number relative to the overall value of the product inventory. For example, the number of counts to be performed may be determined by multiplying the number of part numbers selected from each group (or strata) by the percent value of the respective group relative to the overall value of the product inventory. As one skilled in the art will recognize, because all of the part numbers associated with strata “A” constitute only 5% of the overall value of the inventory, fewer part numbers may be required for auditing from the lower value strata in order to maintain an acceptable error threshold respective to the value of the entire inventory population. Conversely, more part numbers may be required for auditing from the higher value strata (e.g., strata “D”), as loss or error associated with a single product may significantly effect the overall error with respect to the total value of the inventory population.

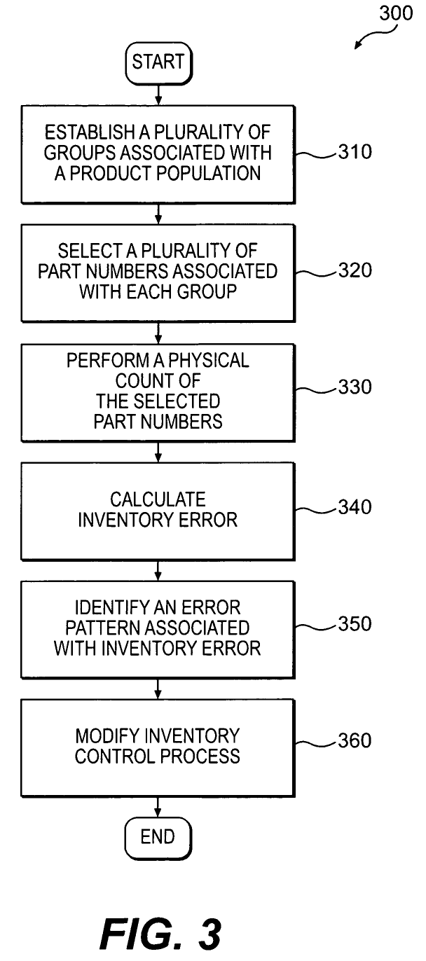

Processes and methods consistent with the disclosed embodiments may enable the control of inventory management processes by identifying and analyzing inventory errors associated with deviations between actual physical count data and inventory records. The inventory control processes may be adjusted to eliminate the source of the inventory error based on the inventory error analysis. For example, FIG. 3 provides a flowchart 300 depicting an exemplary method for managing an inventory control process. The method may comprise establishing a plurality of groups associated with a product population (Step 310). For example, CPU 111 associated with system 110 may be configured to execute stratification software that automatically establishes a plurality of subpopulations from a larger inventory population, based on predetermined criteria and/or user input. For example, a user may select one or more of a number of subgroup divisions and/or a subgrouping criteria associated with a product population using a graphical user interface (GUI) associated with system 110. The stratification software may automatically sort an inventory population (which may be represented electronically in inventory database 103) based on the user inputs. According to one embodiment, the groups may be established using a stratification process, such as the one described in reference to FIG. 2. Alternatively, the groups may be arranged using any suitable automated or manual process based on at least one predetermined criteria, such that each product associated with each of the plurality of groups has at least one aspect in common.

Once a plurality of groups has been established a plurality of samples may be selected from each group (Step 320). The samples may be selected at random, using any suitable type of random sample selection device. According to one embodiment, CPU 111 may execute a random sample selection algorithm that selects one or more part numbers from among a plurality of part numbers stored in inventory database 103. Alternatively, one or more part numbers may be randomly selected manually, by inventory management personnel.

The number of part numbers selected for each group or subpopulation may be determined based on the size of the population associated with the group and/or the value of the group relative to the overall value of the entire inventory. The number of part numbers selected may be predetermined or, alternatively, may be identified using any suitable sample selection algorithm for determining an appropriate statistical sample for a population. For example, the number of part numbers may be determined based on one or more of a total number of elements in the population, an historical standard deviation data associated with inventory error, or a confidence factor that may be required in the statistical test count data. According to one embodiment, system 110 may determine the minimum sample size, n, based on the following formula:

$$n = {( \frac{x}{Δ} )}^{2} \cdot P ( 1 - P ) \qquad ( Eq . 1 )$$

where x is a predetermined constant corresponding to a confidence level which may be obtained from a table (e.g., x=1.96 for a confidence level of 95%); P corresponds to a desired confidence level (e.g., P=0.95 for a desired confidence level of 95%); and A includes an acceptable standard deviation for a particular sample or element. It should be noted that one or more of the variables noted above may be dependent on one or more other variables. For instance, as standard deviation decreases corresponding to a decrease in inventory error associated with the statistical test count, a confidence factor in the test count process may increase. Accordingly, once a desired standard deviation is reached, the sample size may be reduced based on a desired confidence factor associated with the test count process.

Once one or more part numbers have been selected from each of the plurality of groups, a physical count of the selected part numbers may be conducted (Step 330). This physical count may be performed manually by one or more inventory management personnel. Alternatively, the physical count may include a semi-automated process whereby barcodes affixed to each product may be scanned using optical scanning devices or other handheld scanning instruments. The scanned data may be uploaded to system 110, which may automatically sort and count the scanned data to produce physical count data.

Once a physical count has been performed, an inventory error may be determined (Step 340). Inventory error, as the term is used herein, refers to an amount by which a physical count data differs from inventory record data for each of the plurality of selected part numbers. The inventory error may be reflected as a difference (e.g., deficit or surplus) between the actual quantity and the inventory record for a particular part number. For example, if the actual quantity of part number “X” determined by a physical count is 13 units, while the inventory record indicates that there are 15 units, the software may assign an inventory error of −2 to part number “X”. Alternatively, inventory error may be expressed as a variance, a standard deviation, or other suitable statistical representation indicative of a discrepancy between physical count data and data reflected in the inventory record. Although inventory error is described in connection with a quantity discrepancy between physical count data and inventory record data, it is contemplated that inventory error may also be expressed as a monetary value discrepancy.

Once identified, inventory error may be extrapolated over a group associated with the selected part numbers to establish an inventory error associated with the group. For example, by statistically averaging or extrapolating the inventory error associated with one or more individual part numbers over an entire group, an inventory error associated with a particular group may be estimated. Inventory errors associated with each part number may be stored in database 115 for subsequent inventory analysis and testing. Additionally, the inventory record for each part number that contains an inventory error may be adjusted based the respective inventory error for that part number.

Once the inventory record has been modified and an appropriate amount of historical inventory error data has been documented, a potential source of inventory error may be identified based on an inventory error analysis (Step 350). For example, system 110 may identify an source of inventory error by comparing an inventory error associated with each of the selected part numbers with a predetermined inventory error threshold. For example, a predetermined inventory error threshold for any part number in Strata “A” may be set at 0.9%. Accordingly, if system 110 identifies an inventory error associated with a particular part number that exceeds 0.9%, system 110 may identify this part number as containing an unacceptable level of error and may select the part number for further analysis.

Once a potential source of inventory error has been identified, an inventory error analysis may be performed to identify the source of the inventory error. The inventory error analysis may include, for example, comparing the current inventory error with historical inventory error to identify any particular event that may correspond with the inventory error. Accordingly, system 110 may analyze the event in order to identify the error source. For example, system 110 may analyze historical data associated with the inventory error and determine that a particular shipment may be the source of an increase in inventory error.

Based on the inventory error analysis, an inventory control process may be modified to correct the source of inventory error (Step 360). For example, system 110 may be configured to provide an inventory error analysis report to project management personnel. The inventory error analysis report may include one or more recommendations for modifying an inventory control process to correct the source of inventory error. Inventory management personnel may subsequently modify the inventory control process based on the recommendations.

### INDUSTRIAL APPLICABILITY

Although methods consistent with the disclosed embodiments are described in relation to product warehouse environments, they may be applicable to any environment where management of tangible or intangible inventory may be required. According to one embodiment, the disclosed system and method for managing inventory control processes may enable organizations to efficiently recognize and correct inventory control processes through statistical analysis of present and historical inventory error data. As a result, in addition to updating inventory records to accurately reflect physical warehouse data, the presently discloses system and method may efficiently and accurately identify a source of error and take certain measures to ensure that the errors are reconciled.

The presently disclosed system and method for managing inventory control processes may have several advantages. For instance, because an inventory population may be divided into a plurality of groups according to certain predetermined characteristics, the part numbers selected from each group may be more closely related than part numbers that may simply be selected from a large inventory population. Accordingly, inventory analysis (and, by extension, inventory adjustments based on the analysis) may be more accurate than conventional systems that rely on inventory analysis of part numbers selected from a large, general population.

Furthermore, the presently disclosed system may have certain cost advantages over conventional inventory control processes. For example, inventory errors are recognized, diagnosed, and corrected using objective results-based criteria, such as predetermined error thresholds and historical data analysis. Inventory errors may be quickly and objectively identified and inventory control processes may be accurately modified to permanently correct a cause of the error(s), thereby reducing the need for frequent physical counts and stock audits. As a result, costs associated with inventory management resources dedicated to inventory audits may be significantly reduced and/or eliminated.

It will be apparent to those skilled in the art that various modifications and variations can be made to the disclosed system and method for managing inventory control processes. Other embodiments of the present disclosure will be apparent to those skilled in the art from consideration of the specification and practice of the present disclosure. It is intended that the specification and examples be considered as exemplary only, with a true scope of the present disclosure being indicated by the following claims and their equivalents.

What is claimed is:

1. A method for managing an inventory control process, comprising:
establishing a plurality of groups within a product population, each of the plurality of groups having a plurality of products with at least one aspect common to each of the plurality of products;
selecting one or more part numbers associated with one or more of the plurality of groups, wherein a number of selected part numbers is determined based on a total number of part numbers of the one or more of the plurality of groups;
determining an actual quantity associated with each of the selected part numbers;
determining an inventory error associated with each of the selected part numbers based on a difference between the determined quantity and an inventory record associated with each of the selected part numbers;
modifying the inventory record based on the inventory error;
comparing the inventory error with a predetermined error threshold;
analyzing the inventory control process if the inventory error exceeds the predetermined inventory error threshold; and
modifying an inventory control process based on the analysis.

2. The method of claim 1, wherein analyzing the inventory control process includes:
analyzing an existing inventory control process associated with each part number having an inventory error that exceeds the predetermined error threshold;
identifying one or more potential sources of inventory error; and
providing recommendations for modifying the inventory control process to correct the one or more potential sources of inventory error.

3. The method of claim 1, wherein the at least one aspect includes one of a price, a type, a size, or a storage characteristic associated with the plurality of products.

4. The method of claim 1, wherein selecting one or more part numbers from among the plurality of groups includes randomly selecting the one or more part numbers using a stratification software tool.

5. The method of claim 1, wherein modifying the inventory record includes adjusting the inventory record by at least the inventory error associated with each of the selected part numbers.

6. The method of claim 5, wherein correcting the inventory record includes extrapolating the inventory error across the corresponding group.

7. The method of claim 5, wherein correcting the inventory record includes extrapolating the inventory error across the product population.

8. The method of claim 1, wherein determining the inventory error includes:
comparing a standard deviation associated with each of the selected part numbers with a predetermined standard deviation threshold; and
identifying one or more of the part numbers for inventory analysis if the standard deviation associated with the one or more of the selected part numbers exceeds the predetermined standard deviation threshold.

9. The method of claim 8, further including:
performing an inventory analysis on the identified part numbers; and
modifying the inventory process based on the inventory analysis.

10. The method of claim 1, wherein determining a quantity of products associated with each of the selected part numbers includes performing a physical count of each of the selected part numbers, wherein a number of counts of the selected part numbers is based on a value of the respective group associated with each of the part numbers.

11. The method of claim 1, wherein modifying the inventory control process includes one or more of recommending inventory training for one or more inventory personnel, increasing the part numbers selected from each of the plurality of groups, modifying a predetermined inventory error threshold, or adjusting an inventory accounting process.

12. A method for adjusting an inventory management process comprising:
selecting one or more part numbers associated a product population;
collecting physical count data associated with the selected part numbers;
determining an inventory error associated with each of the selected part numbers based on a deviation between the physical count data and an inventory record associated with each of the selected part numbers;
comparing the inventory error with a predetermined error threshold;
analyzing an existing inventory control process associated with each part number having an inventory error that exceeds the predetermined error threshold;
identifying one or more potential sources of inventory error;
providing recommendations for modifying the inventory control process to correct the one or more potential sources of inventory error; and
modifying an inventory control process based on the recommendations.

13. The method of claim 12, wherein selecting one or more part numbers from among the plurality of groups includes randomly selecting the one or more part numbers using a stratification software tool.

14. The method of claim 12, wherein modifying the inventory record includes adjusting the inventory record by at least the inventory error associated with each of the selected part numbers.

15. The method of claim 12, wherein modifying the inventory record includes extrapolating the inventory error across the corresponding group.

16. The method of claim 12, wherein modifying the inventory record includes extrapolating the inventory error across the product population.

17. The method of claim 12, wherein determining inventory error includes:
comparing a standard deviation associated with each of the selected part numbers with historical standard deviation data; and
identifying one or more of the part numbers for inventory analysis if the standard deviation associated with the one or more of the selected part numbers exceeds the historical standard deviation data by a threshold amount.

18. The method of claim 17, further including:
performing an inventory analysis on the identified part numbers; and
modifying the inventory process based on the inventory analysis.

19. A computer readable medium for use on a computer system, the computer readable medium having computer executable instructions for performing a method comprising:
establishing a plurality of groups within a product population, each of the plurality of groups having a plurality of products with at least one aspect common to each of the plurality of products;
selecting one or more part numbers associated with each of the plurality of groups;
determining a quantity associated with each of the selected part numbers;
determining an inventory error associated with each of the selected part numbers based on a difference between the determined quantity and an inventory record associated with each of the selected part numbers;
modifying the inventory record based on the inventory error;
comparing the inventory error with a predetermined error threshold;
analyzing the inventory control process if the inventory error exceeds the predetermined inventory error threshold; and
modifying an inventory control process based on the analysis.

20. The computer readable medium of claim 19, wherein analyzing the inventory control process includes:
analyzing an existing inventory control process associated with each part number having an inventory error that exceeds the predetermined error threshold;
identifying one or more potential sources of inventory error; and
providing recommendations for modifying the inventory control process to correct the one or more potential sources of inventory error.
